(19) United States
(12) Patent Application Publication
(10) Pub. No.: US 2012/0285328 A1
(43) Pub. Date: Nov. 15, 2012

(54) FLAT BAG CONTAINING FUNCTIONAL MATERIAL

(76) Inventors: Amol Kirtikar, Albuquerque, NM (US); Achim Koch, Moosburg (DE); Mathias W. Gluth, Chloorkop (ZA); Joshua V. Klein, Albuquerque, NM (US); Alicia A. Armijo, Los Luans, NM (US)

(21) Appl. No.: 13/468,536

(22) Filed: May 10, 2012

Related U.S. Application Data
(60) Provisional application No. 61/484,798, filed on May 11, 2011.

(51) Int. Cl. B01D 53/04; B65B 1/04

(52) U.S. Cl. 96/153; 53/473

(57) ABSTRACT

A flat bag, and method of producing one, filled with a small quantity of a matrix, such that the matrix is evenly spread over the entire bag to maintain a low profile through all foreseeable handling and transport conditions. The matrix contains a functional material that may be a desiccant, volatile organic chemical absorber, odor absorber, odor emitter, oxygen absorber, or a humectant.

### CROSS REFERENCE TO RELATED APPLICATIONS

The present application hereby claims the benefit of the provisional patent application Ser. No. 61/484,798, filed on May 11, 2011, the disclosure of which is hereby incorporated by reference in its entirety.

### BACKGROUND

Desiccant bags and packets are typically very low cost, but very bulky in their thickness dimension. Some applications that require very low profile desiccants cannot accommodate bulky desiccant bags.

Desiccant loaded polymers, extruded into a sheet form have been proposed as a solution to this problem. However, material costs of the polymers, and the process cost of compounding and extrusion make it prohibitive to use such sheets in cost sensitive applications. Also, in order to use polymers as effective binders, they need to be present in the compound at ratios of 25% to 75%. This drastically reduces the effective moisture absorption capacity of the desiccant. For these reasons, the adoption of desiccant loaded extruded polymers has been limited.

Techniques to produce highly filled sheets include using fibrillated PTFE as a binder is known. These require 5-10% of PTFE to be added to the fill material. Due to the very high cost of PTFE, even a 5% loading is cost prohibitive for some applications. Also, some users are very sensitive to halogen content of the products they use. At a 5% content of PTFE, the halogen content of the desiccant would be beyond permissible limits.

It may be possible to produce a very thin profile desiccant bag, by using very large bag dimensions, and filling a relatively small weight of desiccant material into the bag. When the material is evenly spread out, the desiccant bag would have a very thin profile. However, when such a product is transported, or otherwise handled, the distribution of the desiccant material inside the bag would no longer be even and all of it would accumulate on one side of the bag, again making it bulky.

### BRIEF SUMMARY

A flat bag, and method of producing one, filled with a small quantity of a matrix, such that the matrix is evenly spread over the entire bag to maintain a low profile through all foreseeable handling and transport conditions. The matrix contains a functional material that may be a desiccant, volatile organic chemical absorber, odor absorber, odor emitter, oxygen absorber, or a humectant.

These and other objects and advantages shall be made apparent from the accompanying drawings and the description thereof.

### BRIEF DESCRIPTION OF THE FIGURES

The accompanying drawings, which are incorporated in and constitute a part of this specification, illustrate embodiments, and together with the general description given above, and the detailed description of the embodiments given below, serve to explain the principles of the present disclosure.

FIG. 1 is a photograph of an opened desiccant bag.

FIG. 2 is a schematic of a desiccant bag.

FIG. 3 is an embodiment of a pouch with an integrated flat desiccant bag.

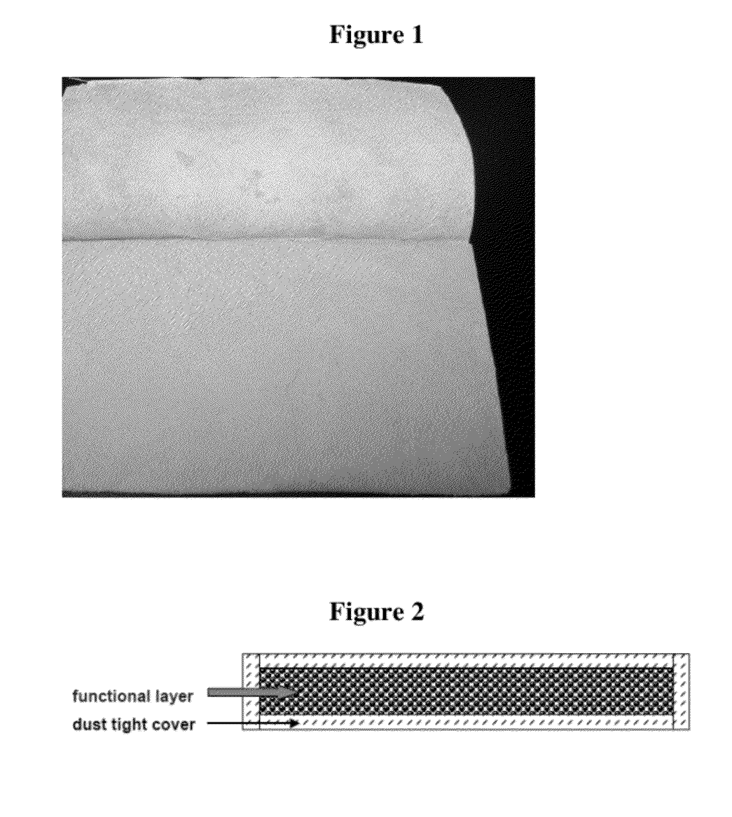

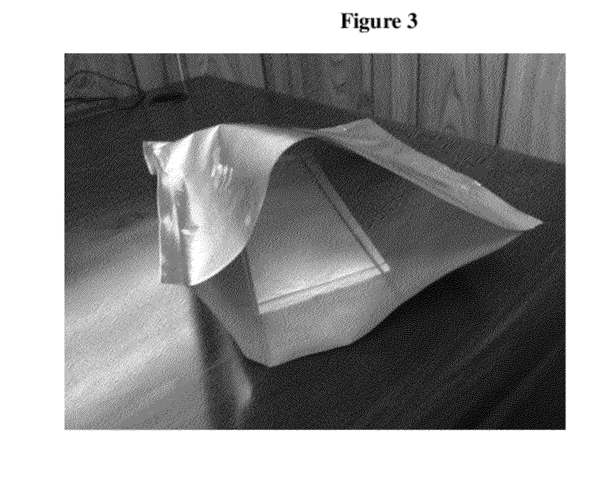

### DETAILED DESCRIPTION

A flat bag comprises a friable matrix including a binder and a functional material in a bag; wherein the binder is 20% or less of the matrix, and the thickness of the bag and matrix is 10 mm or less; wherein the functional material is selected from a desiccant, volatile organic chemical absorber, odor absorber, odor emitter, oxygen absorber, or a humectants. The flat bag is durable and is able to maintain its shape despite being held vertically. It can be very thin and contain a small amount of functional material without the functional material accumulating at one side or corner when the bag is handled. Yet the matrix material is friable and will flow during the manufacturing of the bag.

In one embodiment the thickness of the flat bag and matrix is from about 0.2 to about 10 mm, about 0.2 mm to about 5 mm, about 1.5 mm to about 3.5 mm, or about 1 mm to about 2 mm. The thickness of the flat bag and matrix depends upon the dimensions of the bag, the bag material and its thickness, and the amount of matrix. In one embodiment the binder is blended with the functional material in powder form and fibrillated to form a network of nodes and fibrils (matrix). The functional material is trapped in the matrix.

Examples of functional materials include desiccants, volatile organic chemical absorbers, odor absorber, odor emitter, oxygen absorber, or humectants. Examples of function material include, but are not limited to clay, silica gel, molecular sieves, calcium oxide, magnesium oxide, iron, copper ions, ascorbic acid, and activated carbon.

The matrix is a friable material. It maintains its shape but can be easily broken into smaller pieces. It is this friability that allows the matrix to flow. But the matrix is durable enough so that it can maintain its flat shape in a bag despite handling. It does not need to be packed tightly into a bag so that it cannot change shape. The matrix is not made of tightly packed beads. Instead it uses a binder such as a fibrillated polymer, adhesive, or thermoplastic polymer to loosely hold it together.

The binder is used to hold the functional material together preventing it from flowing and collecting in one area of the bag. The matrix formed is not be a film or sheet. It may have a dough-like consistency. The amount of binder needed depends upon which binder and functional material used. In one embodiment the matrix may comprise 20% or less, 10% or less, 1% or less, about 0.1% to about 10%, about 0.1% to about 5%, about 0.1% to about 2%, or about 0.1% to about 1% of the binder.

In one embodiment the binder may be a fibrillatable polymer, such as PTFE (polytetrafluoroethylene) or cellulose. In one embodiment the binder may be an adhesive. In one embodiment, the binder may be a thermoplastic polymer

The amount of PTFE may be optimized to ensure enough adhesion to retain flatness of the bag while retaining enough flowability of the blended powder to enable the bags to be filled with a bag form-fill-seal machine. In one embodiment less that 1% PTFE binder is needed for the matrix. Such a low content of PTFE does not dilute the effective capacity of the desiccant. It also reduced the overall cost because PTFE is more expensive than the desiccant. It also reduces the halogen content of the matrix, which is important for halogen sensitive items.

The desiccant is used to dry the air around the flat bag to protect something sensitive to ambient moisture. In one embodiment the desiccant is selected from clay, silica gel, molecular sieve, calcium oxide, and magnesium oxide. In one embodiment the desiccant is bentonite clay. Fine bentonite desiccant dust, which is often discarded as waste may be used.

The bag used to hold the matrix is moisture permeable, but will not allow the matrix to pass through it. A desiccant bag with a larger surface to volume ratio will be thinner when laid flat. This greater surface area will increase the rate of desiccation for the same volume of desiccant.

In one embodiment the bag is made from a composition that is not dust permeable. In one embodiment it is also able to withstand temperatures up to about 245° F. It is desirable that the bag composition be non-shedding and has a high tensile strength. It is also desirable that the bag composition be tear and puncture resistant and is heat sealable. For a bag that contains a desiccant it is desirable that the bag composition has a high moisture transmission rate. In one embodiment the bag is made from two sheets which are sealed together to contain the matrix. The sheets may be made from many different types of materials such as: flash-bonded polyethylene (high density polyethylene) such as Tyvek; polyester (65%-71%)/polypropylene (35%-29%) such as GDII (non-woven); polyester nonwoven bi component PE-PET such as PGI; cellulose such as Kraft; coated cellulose such as Crepe; laminated cellulose such as Claf; polyethylene; polypropylene; polyethylene terephthalate; polyester spunbonded non-wovens such as Reemay; Clear Film; or Opaque film.

In one embodiment the flat desiccant bag has one side that is moisture permeable and the opposite side is made from a different material that is not moisture permeable. The non-moisture permeable side may be made from aluminum foil or Mylar. In one embodiment the flat desiccant bag may be integrated into a pouch. One side of the flat desiccant bag is formed from one wall of the pouch, which is not moisture permeable. The other side of the flat desiccant bag is internal to the pouch and is moisture permeable. In this embodiment the flat desiccant bag will not fall out of the pouch and it reduces the material costs because the flat desiccant bag only requires a single side that is moisture permeable. In one embodiment the flat bag may have an adhesive layer on one side of the bag.

The matrix is formed by blending the binder and the functional material. In one embodiment during the formation of the matrix the binder is fibrillated. During the blending, the mixture may be heated to about 80° C.-120° C. In one embodiment the matrix is formed by mixing and fibrillating PTFE with the desiccant. The amount of fibrillation may affect the ability of the matrix to flow. When there is more fibrillation the matrix may not flow as well, but will maintain its shape better. When there is less fibrillation the matrix may flow more easily, but will not hold its shape as well. The amount of fibrillation may be optimized so that the matrix may be handled easily, flow well, but still retain the ability hold its shape in a desiccant bag. In one embodiment the matrix is of an appropriate particle size and amount of fibrillation that it will maintain its shape for a time of at least 5 minutes, 10 minutes, 20 minutes, 30 minutes, or 1 hour when subjected to a shaking test.

The particle size of the desiccant affects the ability of the matrix to be easily handled during manufacturing. If the particle size is too small the matrix will not flow easily and will clump up. Without a good flow, it is difficult to use the matrix to fill a desiccant bag. One measurement of the ability of the matrix to flow is the angle of repose. A lower angle of repose corresponds to a better ability to flow. In one embodiment the angle of repose of the desiccant is 36° or less, 35° or less, 34° or less, 33° or less, 32° or less, 31° or less, 30° or less. The particle size that results in the desired angle of repose is dependent upon the functional material used. In one embodiment, the average particle size of a desiccant is from about 54 μm to about 138 μm, about 77 μm to about 107 μm, about 90 μm to about 95 μm, or about 90 μm. The particle size of the desiccant also has an effect on the amount of dust created. When the particle size is smaller more dust is created during the manufacturing process.

In one embodiment, silica gel, as desiccant, may be used as the functional material. The average particle size for a matrix containing silica gel may be from about 20 μm to about 65 μm; about 40 μm to about 65 μm; or a 1:1:1 mixture of silica gel particles with an average size of 20 μm, 40 μm, and 65 μm.

In one embodiment, molecular sieves, a desiccant, may be used as the functional material. The average particle size of the molecular sieves may be about 75 μm. The fibrilization of the binder may take between about 10 minutes and 30 minutes.

The particles may be created by using a blender or grinder. The method of creating the particles may affect the particle size distribution. A tighter particle size distribution will have poorer flow characteristics, but better durability. In one embodiment the particle size distribution is ±90 μm. In another embodiment the particle size distribution is ±30 μm.

After the matrix is formed by active blending of the functional material and the binder, the matrix is compressed. The matrix is compressed into a flat shape that it will maintain. Without the compression the matrix will still flow and will not have the desirable durable properties. In one embodiment the matrix is compressed by passing it through a set of rollers, which reduces its thickness and spreads it out. The rollers may be adjacent rollers rotating in opposite directions with the matrix passing between them. There may be more than one set of rollers that gradually reduce the thickness of the matrix. In one embodiment the compression is applied by vacuum compressing or between two flat plates. In one embodiment, during the compression of the matrix it is heated. The matrix may be compressed in the bag or prior to being sealed in the bag.

In one embodiment the process for making a flat bag comprising the steps of: blending a mixture of a binder and the functional material to form a matrix; adding the matrix to a bag; and compressing the matrix to form a friable matrix.

A desiccant or other functional material may need to be activated before, during, or after the formation of the matrix. In one embodiment the desiccant may be activated prior to mixing with a binder to form a matrix. In one embodiment the desiccant is activated after the matrix has been compressed.

The matrix is filled into the bag in a normal desiccant bag making operation. The use of an outer bag allows the binder content (such as PTFE) of the desiccant blend to be significantly less than what would have been necessary in order for a desiccant sheet to have its own strength. Just enough binder is required that the matrix inside the bag retain its shape when pressed together, without flowing inside the bag. Any further mechanical strength is provided by the outer bag.

In one embodiment desiccant bags can be produced in a continuous string of bags. Such a string of bags can be passed through a set of rollers to spread the material evenly within the bag, and to compress it to some extent. The bags may be singulated at a later time or different location. Such a process is much simpler and lower cost than other known methods of sheeting, such as extrusion, or compression molding. In one embodiment the desiccant may be added to discrete bags. The matrix may be compressed by passing it through a set of rollers or more than one set of roller. The rollers may be heated to 80° C.-120° C.

While the present disclosure has illustrated by description several embodiments and while the illustrative embodiments have been described in considerable detail, it is not the intention of the applicant to restrict or in any way limit the scope of the appended claims to such detail. Additional advantages and modifications may readily appear to those skilled in the art.

### EXAMPLES

### Example 1

Bentonite clay and PTFE powder (or aqueous dispersion) are mixed in the proper ratio (eg: 99:1) and the blend is homogenized.

The blend is mixed at a temperature between 80° C.-120° C., in a mixer while introducing adequate shear to produce fibrillation of the PTFE. Techniques to mix PTFE with powder substances while fibrillating the PTFE are well known in the industry.

The blend is heated in an oven to activate the clay.

The blend is filled into bags using a form-fill-seal machine. The bags are not separated but retained in a continuous strip.

Either inline with the filling process or offline in a separate process, the string of bags is passed through a set of rollers, with progressively thinner clearance. The rollers are preferably heated to 80° C.-120° C.

The bags are then singulated from the continuous strip.

### Example 2

### Creating the Matrix

Clay dryer dust was blended for two minutes in a blender on a high speed setting. The material was sieved through US mesh plans: 80, 100, 120, 170, 230, 325, and pan. The clay dryer dust was re-blended and sieved until there is approximately 550 grams of each particle size.

Particle sizes

| Mesh | Particle size min (μ) | Particle size max (μ) |
|---|---|---|
| 80 | 180 | 300 |
| 100 | 150 | 180 |
| 120 | 125 | 150 |
| 170 | 90 | 125 |
| 230 | 63 | 90 |
| 325 | 45 | 63 |
| pan | 0 | 45 |

Eight samples were formed from the clay dryer dust (512 g, each particle size) and PTFE (5.2 g). The eighth sample used a mixture of the 230/325/and pan meshes in a 1:1:1 mixture (170.6 g of each particle size).

Each of the eight samples was intensively mixed in an Osterizer blender on a speed setting of 10 (approximately 8000 rpm) for five minutes. The blender was inverted every minute to redistribute the packed material at the bottom of the blender.

Each of the eight samples underwent working action mixing using a Kitchen Aid mixer fitted with a spade beater without a rubber blade for five minutes at about 58-60 rpm. During the mixing the material was redistributed to prevent caking along the edge of the bowl. The mixing bowl was heated by using a water jacket. The temperature of the mixture was about 70-80° C. by the end of the mixing.

### Example 3

### Shaking Test

The samples were then sieved through on a pan mesh to break up any clumps. Each sample (34 grams, before and after sieving) was placed into a 5″×8″ polyester non-woven bag (70 gsm biocomponenet PE-PET) and flattened with a round weight. The ease of rolling and flattening the bag was graded on a scale of 1-10; where 1=difficult and 10=easy.

The amount of dust produced was measured by using a clean black table on which the bags were flattened. The results were graded on a scale of 1-10; where 1=heavy dust and 10=no dust.

The flattened bags were placed vertically on a shaker table for 30 minutes. The shaker table was a table that moves in a circular vibratory motion in a vertical plane by an eccentric with a 0.5 inch throw at 300±5 cycles per minute. The bags were attached by a piece of tape across the top of the bags.

### Example 4

### Angle of Repose Test

The samples (40 grams) were sieved on a pan mesh to break up any clumps. The samples were placed on a vibratory feeder (Eriez Hi Vi Vibratory Equipment, Model 15A, Style 26, tuned at 0.043) and allowed to fall through a funnel (powder funnel with a 4.25″ diameter top and 0.75″ diameter bottom) onto a petri dish to form a powder cone. The vibratory feeder was set at #50. The angle of repose was calculated from the base and height of the cone using the equation: tan(angle of repose)=height/½ base.

Sample Results Before Sieve

| Mesh size | Ease of Flattening | Shake Test Time | Dust |
|---|---|---|---|
| 80 | 5 | 0 | 6 |
| 100 | 7 | 0 | 6 |
| 120 | 8 | 8 seconds | 8 |
| 170 | 9 | >30 minutes | 9 |
| 230 | 10 | >30 minutes | 10 |
| 325 | 9 | >30 minutes | 10 |
| pan | 8 | >30 minutes | 10 |
| 230/325/pan mix | 9 | >30 minutes | 10 |

Sample Results After Sieving

| | Ease of | | | Angle of |
|---|---|---|---|---|
| Mesh size | Flattening | Shake Test Time | Dust | Repose |
| 80 | 5 | 0 | 5 | 22.1 |
| 100 | 7 | 0 | 5 | 28.1 |
| 120 | 8 | 0 | 5 | 33.1 |
| 170 | 9 | 1 minute 5 seconds | 8 | 32.8 |
| 230 | 10 | >30 minutes | 10 | 34.6 |
| 325 | 10 | >30 minutes | 10 | 35.7 |
| pan | 10 | >30 minutes | 10 | 38.1 |
| 230/325/pan mix | 10 | >30 minutes | 10 | 34.7 |

What is claimed is:

1. A flat bag containing a friable matrix comprising a binder and a functional material in a bag, wherein the binder is 20% or less of the matrix and the thickness of the bag and matrix is 10 mm or less; wherein the functional material is selected from a desiccant, volatile organic chemical absorber, odor absorber, odor emitter, oxygen absorber, or a humectants.

2. The flat bag of claim 1, wherein the binder is a fibrillated polymer.

3. The flat bag of claim 2, wherein fibrillated polymer is PTFE.

4. The flat bag of claim 1, wherein the functional material is a desiccant selected from clay, silica gel, molecular sieve, calcium oxide, and magnesium oxide.

5. The flat bag of claim 4, wherein the desiccant is bentonite clay.

6. The flat bag of claim 4, wherein the desiccant has a particle size range of about 76 μm to 107 μm.

7. The flat bag of claim 1, wherein the matrix has an angle of repose of 32° or less.

8. The flat bag of claim 1, wherein the matrix has a shake test time of at least 5 minutes.

9. The flat bag of claim 1, wherein one side of the flat bag is moisture permeable and the other side is moisture impermeable.

10. The flat bag of claim 9, wherein the moisture impermeable side of the flat bag forms a part of one side of a pouch.

11. A flat bag containing a friable matrix comprising a fibrillated polymer and a functional material in a bag, wherein the matrix has an angle of repose of 32° or less and a shake test time of at least 5 minutes; wherein the functional material is selected from a desiccant, volatile organic chemical absorber, odor absorber, odor emitter, oxygen absorber, or a humectant.

12. The flat bag of claim 11, wherein the average particle size of the functional material is from about 76 μm to about 107 μm.

13. The flat bag of claim 12, wherein the average particle size of the functional material is about 90 μm to about 95 μm.

14. The flat bag of claim 11, wherein the particle size distribution of the functional material is ±90 μm from the average particle size.

15. A process for making a flat bag comprising the steps of:
blending a mixture of a binder and a functional material to form a matrix;
adding the matrix to a bag;
compressing the matrix to form a friable matrix; and
wherein the functional material is selected from a desiccant, volatile organic chemical absorber, odor absorber, odor emitter, oxygen absorber, or a humectant.

16. The process of claim 15, wherein the binder is a fibrillated polymer.

17. The process of claim 15, wherein the matrix has an angle of repose of 32° or less and a shake time of at least 5 minutes.

18. The process of claim 15, wherein the flat bag is in a continuous string of bags, and the process comprises an additional step of singulating an individual desiccant bag from the continuous string of bags.

19. The process of claim 15, wherein during the blending the binder is fibrillated.

20. The process of claim 19, wherein after the binder is fibrillated the matrix is sieved.
